(19) United States
(12) Patent Application Publication
(10) Pub. No.: US 2024/0289612 A1
(43) Pub. Date: Aug. 29, 2024

(54) METHOD AND APPARATUS FOR OPTIMIZING INFERENCE OF DEEP NEURAL NETWORKS

(71) Applicant: Intel Corporation, Santa Clara, CA (US)

(72) Inventors: Haihao SHEN, Shanghai (CN); Hengyu MENG, Shanghai (CN); Feng TIAN, Shanghai (CN)

(21) Appl. No.: 18/571,150

(22) PCT Filed: Oct. 26, 2021
(86) PCT No.: PCT/CN2021/126456

§ 371 Date: Dec. 15, 2023

(51) Int. Cl. G06N 3/08; G06N 5/04

(52) U.S. Cl. CPC G06N 3/08; G06N 5/04

(57) ABSTRACT

The application provides a hardware-aware cost model for optimizing inference of a deep neural network (DNN) comprising: a computation cost estimator configured to compute estimated computation cost based on input tensor, weight tensor and output tensor from the DNN; and a memory/cache cost estimator configured to perform memory/cache cost estimation strategy based on hardware specifications, wherein the hardware-aware cost model is used to perform performance simulation on target hardware to provide dynamic quantization knobs to quantization as required for converting a conventional precision inference model to an optimized inference model based on the result of the performance simulation.

### TECHNICAL FIELD

Embodiments described herein generally relate to deep neural networks (DNNs), and more specifically to a method and apparatus for optimizing low precision inference of DNNs.

### BACKGROUND

DNNs have been rapidly improving in recent years and shown state-of-the-art (SOTA) accuracy for a wide range of computation vision tasks.

### BRIEF DESCRIPTION OF THE DRAWINGS

Embodiments of the disclosure will be illustrated, by way of example and not limitation, in conjunction with the figures of the accompanying drawings in which like reference numerals refer to similar elements and wherein:

FIG. 1 is a diagram showing a typical DNN operator to illustrate computation of estimated computation cost according to an embodiment of the disclosure.

FIG. 2 is a diagram howing a typical DNN operator execution flow according to an embodiment of the disclosure.

FIG. 3 is a diagram showing how to build a hardware (HW)-aware cost model according to an embodiment of the disclosure.

FIG. 4 is a diagram showing a quantization flow with HW-aware cost model according to an embodiment of the disclosure.

FIG. 5a is a diagram showing a convolution operator in a FP32 model according to an embodiment of the disclosure.

FIG. 5b is a diagram showing a Conv operator with Quantize and DeQuantize in an INT8 model according to an embodiment of the disclosure.

FIG. 6a is a diagram showing a FP32 model using Residual Networks (ResNet)-V2 (ResNetV2) according to an embodiment of the disclosure.

FIG. 6b is a diagram showing an INT8 model using ResNetV2 according to an embodiment of the disclosure.

FIG. 6c is a diagram showing a HW-aware cost model driven INT8 model according to an embodiment of the disclosure.

FIG. 7 is a flowchart showing a method for optimizing inference of DNN according to an embodiment of the disclosure.

### DETAILED DESCRIPTION

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well-known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrases “in an embodiment” “in one embodiment” and “in some embodiments” are used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B).”

Although DNNs have been rapidly improving in recent years for a wide range of computation vision tasks, it still faces challenges during industrial deployment due to its high computational complexity of inference. Low precision is one of the key techniques being actively studied recently to conquer the problem. With hardware acceleration support like Intel DL Boost VNNI starting from 2^{nd} generation Intel® Xeon® Scalable Processors, Advanced Matrix Extension (AMX) on future generation of Intel® Xeon® Scalable Processors, and DPAS on Intel® Xe architecture, low precision inference can compute more operations per second, reduce the memory access pressure and better utilize the cache, and deliver higher throughput and lower latency.

8-bit low precision (INT8) is a widely used practice recently used to accelerate the inference. However, 8-bit for all operators in a DNN model is challenging due to very strict accuracy requirement, especially for those recommendation systems. To keep the accuracy, some operators require higher precision, e.g., FP32. How to achieve the optimal low precision model with respective to performance while keeping accuracy is the problem the disclosure wants to address.

Previous approaches discussed some fall back mechanisms simply from INT8 to FP32 with the sacrifice of the performance to some extent. In the disclosure, it introduces a HW-aware performance cost-modelling to produce the optimal low precision model given some operators may have to run into higher data type due to the impact of numeric precision to the model accuracy. The disclosure is the first attempt to explore HW-aware performance simulation for low precision inference and nay be applied in various deep learning products (e.g., code generation in one DNN graph) at Intel.

An aspect of the disclosure provides a hardware-aware cost model for optimizing low precision inference of a deep neural network (DNN) comprising: a computation cost estimator configured to compute estimated computation cost based on input tensor, weight tensor and output tensor from the DNN; and a memory/cache cost estimator configured to perform memory/cache cost estimation strategy based on hardware specifications, wherein the hardware-aware cost model is used to perform performance simulation on target hardware to provide dynamic quantization knobs to quantization as required for converting a conventional precision inference model to a low precision inference model based on the result of the performance simulation.

An aspect of the disclosure provides a method for optimizing low precision inference of deep neural network (DNN) comprising: constructing a hardware-aware cost model comprising: a computation cost estimator configured to compute estimated computation cost based on input tensor, weight tensor and output tensor from the DNN; and a memory/cache cost estimator configured to perform memory/cache cost estimation strategy based on hardware specifications, and using the hardware-aware model to perform performance stimulation on target hardware to provide dynamic quantization knobs to quantization as required for converting a conventional precision inference model to a low precision inference model based on the result of the performance simulation.

An aspect of the disclosure provides a computer-readable storage medium with program instructions stored thereon which, when executed by a processor, cause the processor to: construct a hardware-aware cost model comprising: a computation cost estimator configured to compute estimated computation cost based on input tensor, weight tensor and output tensor from the DNN; and a memory/cache cost estimator configured to perform memory/cache cost estimation strategy based on hardware specifications, and use the hardware-aware model to perform performance stimulation on target hardware to provide dynamic quantization knobs to quantization as required for converting a conventional precision inference model to a low precision inference model based on the result of the performance simulation.

The disclosure describes an effective HW-aware performance simulation for low-precision inference, which can produce an optimal low precision model for deployment rapidly. The performance model simulates the operator execution with input/output and weight tensor for a low precision model by leveraging HW capability omprising but not limitd to computation ops, memory bandwidth, and last level cache (LLC).

Some widely used items in DNN will be introduced herein to demonstrate the idea of the disclosure. Typically, a DNN model is described as a computation graph with nodes and edges, where nodes are DNN operators with one or more tensors as inputs and edges reflect the direction on how tensors can flow. The disclosure are focusing on the inference, which basically means how the computation graph executes given a pre-trained weight file (with weight tensors) and input tensor.

To build the effective HW-aware performance simulation, it needs to construct a HW-aware cost model, which basically comprises a computation cost estimator and a memory/cache cost estimator based on HW specification.

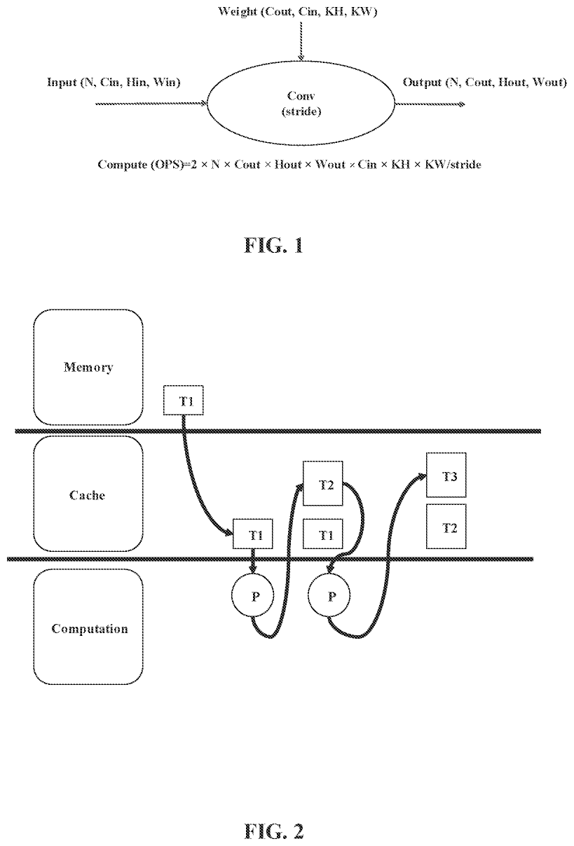

As for the computation cost estimator, a typical DNN operator Conv is used to illustrate the computation of estimated computation cost, as shown in FIG. 1.

Assuming Conv has an input tensor with dimensions of (N, Cᵢₙ, Hᵢₙ, Wᵢₙ), wherein N is batch size, Cᵢₙ is input channel count, Hᵢₙ is height of input data and Wᵢₙ is width of input data; a weight tensor with dimensions of (Cₒᵤₜ, Cᵢₙ, KH, KW), wherein Cₒᵤₜ is output channel count, Cᵢₙ is input channel count, KH is kernel height and KW is kernel width; and an output tensor with dimensions of (N, Cₒᵤₜ, Hₒᵤₜ, Wₒᵤₜ), wherein N is batch size, Cₒᵤₜ is output channel count, Hₒᵤₜ is height of output data and Wₒᵤₜ is width of output data, the computation ops are computed by T=2×N×Cₒᵤₜ×Hₒᵤₜ×Wₒᵤₜ×Cᵢₙ×KH×KW-Stride of Conv, where Stride is an attribute of Conv that impacts the convolution computation. Given a HW with t ops per cycle, the required Conv cost is (T/t) cycles. Based on HW specification, the estimated computation cost can be computed.

As for memory/cache cost estimator, assuming that it follows modern compute architecture with memory and cache. To simplify the cost estimator, level 1 (L1) cache has been excluded due to the cache size is too small to fit typical deep learning applications. It is also assumed that the memory management with ping-pong buffer would be widely adopted by mainstream deep learning frameworks. As a result, it is described several cases in memory/cache cost estimation: 1) if the tensor size is bigger than cache size, then do not cache it; 2) if the tensor can fit in cache free space, then cache it; and 3) if the tensor cannot not fit in free space, then clear the cache and cache it.

FIG. 2 shows a typical DNN operator execution flow with data residence in memory/cache, and computation, where T1, T2, and T3 are tensors which are read from memory or cache, and P represents a DNN operator.

In the disclosure, the memory/cache cost estimation strategy for input/output tensor and weight tensor will be discussed respectively.

Specifically, the memory/cache cost estimation strategy for input/output tensor is as below: reading the input tensor from a cache or a memory; checking whether the input tensor is needed for successive layers; caching the input tensor if the input tensor is needed for successive layers and the tensor size of the input tensor is smaller than cache size; popping the input tensor from the cache if the input tensor is not needed for successive layers or the tensor size of the input tensor is bigger than cache size; updating cache status, and caching the output tensor until there is no free space in the cache.

Further, the memory/cache cost estimation strategy for weight tensor is as below: reading the weight tensor from a cache or a memory; and caching the weight tensor until there is no free space in the cache, since weight tensor is constant and can be re-used during inference cycle. In the case that the weight tensoe cannot be cached as there is no free space in cache, the weight tensor can be read from memory, although rading the weight tensor from the memory will be much slower than reading from the cache.

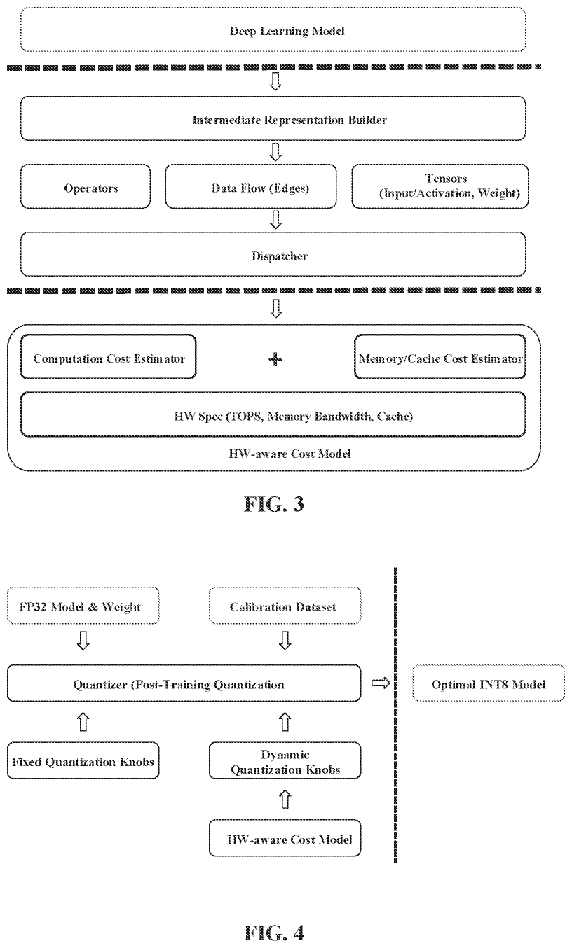

With the computation cost estimator and memory/cache cost estimator, the following will describe how to build a HW-aware cost model, which is constructed on top of intermediate representation (IR) builder, and dispatcher given a deep learning model. FIG. 3 shows how to build the HW-aware cost model according to the disclosure.

Note that the HW-aware cost model according to the disclosure can provide easy extension capability to support new precisions (e.g., BFloat16, BFloat8, etc) and new HWs (4th Gen Xeon generation Sapphire Rapids, Xe architecture GPUs like Artic Sound/Ponte Vecchio, etc).

The HW-aware cost model accoridng to the disclosure can be used in many related areas for performance optimizations in deep learning domains (e.g., low precision optimization, optimal code generation, etc). In the following, post-training quantization, one of typical low precision optimization techniques, will be used as the primary example to show the benefits of the HW-aware cost model according to the disclosure.

FIG. 4 shows a typical quantization flow, wherein the calibration dataset is usually part or whole of validation dataset which is used to avoid over fitting during the training of neural network, which is well known in the art. Comparing with traditional fixed quantization knobs, the HW-aware cost model can provide dynamic and more optimal quantization knobs to quantization based on performance simulation on target HW. Given a new HW with different specifications like more arithmetic and logic units (ALUs), higher cache bandwidth or wider register, it can easily create a new visual HW-aware cost model and perform performance simulation on the created visual HW-aware cost model. For example, wider registers means more operations in a cycle which can directly reduce computation time, higher cache bandwidth can save input/output (I/O) time, etc. Moreover, for a specific HW, the quantization can be updated to find best settings. For example, the quantization can be updated by updating the HW-aware cost model, which can be achieved by excluding some nodes from quantization, inserting quantization/dequantization pairs and then performing performance simulation on the HW-aware cost model again. The process can be performed repeatedly until the best settings is found.

The current quantization knob involved in HW-aware cost model is precision (e.g., INT8, BFloat16, FP32) but can be extended to support other knobs like quantization granularity (e.g., per-channel or per-tensor for weight quantization) and quantization scheme (e.g., symmetric or asymmetric for activation quantization).

Next, some examples from individual operator to model level will be demonstrated to show how the HW-aware cost model according to the disclosure can benefit for low precision optimization. Table 1 shows the HW specification for Copper Lake (CLX) processor, Cascade Lake (CPX) processor, and Sapphire Rapids (SPR) with theoretical INT8 TOPS and memory bandwidth.

TABLE 1
Xeon HW Specification

| HW | INT8 TOPS | Memory Bandwidth |
|---|---|---|
| Copper Lake (CLX) 1 | 16.8 T | 141 GB/s |
| socket (28 cores) | | |
| Cascade Lake (CPX) 1 | 19.8 T | 154 GB/s |
| socket (28 cores) | | |
| Sapphire Rapids (SPR) 1 | 235 T | 307 GB/s |
| socket (56 cores) | | |

FIG. 5a shows a Conv operator in a FP32 model and FIG. 5b shows a Conv operator with Quantize and DeQuantize in an INT8 model as an example of individual operator. The INT8 model as shown in FIG. 5b adopts the quantization knobs provided by the HW-aware cost model as shown in FIG. 4, that is, the HW-aware cost model provides dynamic and more optimal quantization knobs to quantization based on performance simulation on target HW. Table 2 shows up to 2.6×, 2.8×, and 10.2× on CLX, CPX, and SPR respectively.

TABLE 2
Performance Speedup on Individual Operator (Conv)

| | Improvement Ratio |
|---|---|
| HW | (INT8 Model vs. FP32 Model) |
| CLX | 264.7% |
| CPX | 287.9% |
| SPR | 1023.3% |

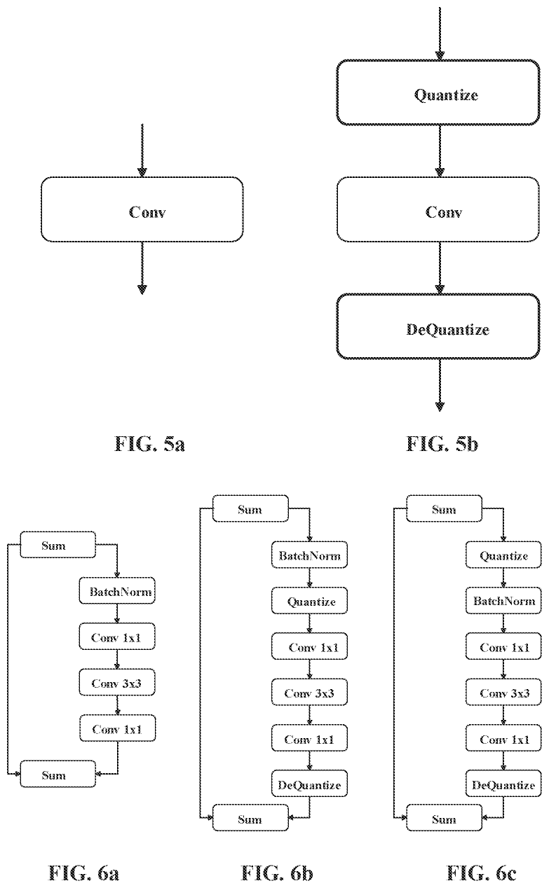

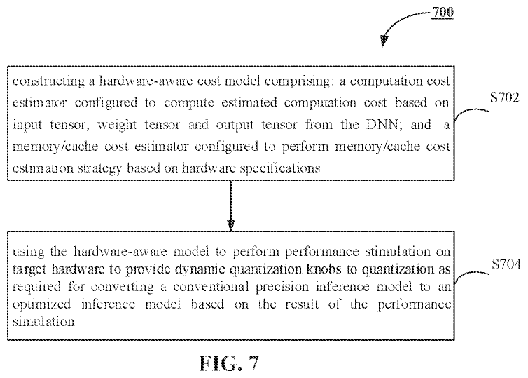

FIG. 6a shows a FP32 model using ResNetV2, FIG. 6b shows an INT8 model using ResNetV2, and FIG. 6c shows a HW-aware cost model driven INT8 model in which the HW-aware cost model provides dynamic and more optimal quantization knobs to quantization based on performance simulation on target HW. Table 3 shows that the HW-aware cost model according to the disclosure can bring additional 6% on CLX/CPX and 23% on SPR using cost-model driven INT8 vs. default INT8.

TABLE 3
Performance Speedup on Residual Block
(Cost-model driven INT8 vs. Default INT8)

| | Improvement Ratio |
|---|---|
| HW | (INT8 Model 2 vs. INT8 Model 1) |
| Cascade Lake (1 socket) | 6.7% |
| Copper Lake (1 socket) | 6.2% |
| Sapphire Rapids (1 socket) | 23% |

The public ResNetV2-101 model is used to verify the performance benefits on cost-model driven INT8 model vs. FP32 model. Table 4 shows the performance speedup on ResNetV2-101 model.

TABLE 4
Performance Speedup on ResNetV2-101 Model

| | Improvement Ratio |
|---|---|
| HW | (INT8 Model vs. FP32 Model) |
| Cascade Lake (1 socket) | 224% |
| Copper Lake (1 socket) | 206% |
| Sapphire Rapids (1 socket) | 254% |

In summary, it can be seen up to 23% performance speedup on a single residual block between two INT8 models (cost-model driven INT8 vs. default INT8) and up to 254% on cost-model driven INT8 vs. FP32 model. Considering other models like ResNetV2-152 or ResNetV2-269 with more similar residual blocks, the estimated performance speedup is ˜300%. It can be even expected that much bigger performance will be gained on future HW generation (e.g., Artic Sound/Ponte Vecchio) with more powerful computation but relatively less powerful memory bandwidth.

With the disclosure, it can help Intel deliver highly efficient INT8 inference in DNN models on Intel® Xeon® Scalable Processors and Intel® Xe architecture and therefore wins more critical customers. It can also promote the solution into all Intel® optimized deep learning frameworks and help high profile customers (e.g., Google, Facebook) deploy INT8 inference on cloud service rapidly.

FIG. 7 a flowchart showing shows a method according to an embodiment of the disclosure. As shown in FIG. 7, the method 700 comprises: S702, constructing a hardware-aware cost model comprising: a computation cost estimator configured to compute estimated computation cost based on input tensor, weight tensor and output tensor from the DNN; and a memory/cache cost estimator configured to perform memory/cache cost estimation strategy based on hardware specifications, and S704, using the hardware-aware model to perform performance stimulation on target hardware to provide dynamic quantization knobs to quantization as required for converting a conventional precision inference model to a low precision inference model based on the result of the performance simulation.

In some embodiments, the conventional precision inference model comprises FP32 model.

In some embodiments, the low precision inference model comprises Bfloat16 model, Bfloat8 model and INT8 model.

In some embodiments, the quantization is post-training quantization.

In some embodiments, the input tensor has four dimensions and is represented as input (N, Cᵢₙ, Hᵢₙ, Wᵢₙ), wherein N is batch size, Cᵢₙ is input channel count; Hᵢₙ is height of input data and Wᵢₙ is width of input data.

In some embodiments, the weight tensor has four dimensions and is represented as input (Cₒᵤₜ, Cᵢₙ, KH, KW), wherein Cou is output channel count, Cᵢₙ is input channel count; KH is kernel height and KW is kernel width.

In some embodiments, the output tensor has four dimensions and is represented as input (N, Cₒᵤₜ, Hₒᵤₜ, Wₒᵤₜ), wherein N is batch size, Cₒᵤₜ is output channel count; Hₒᵤₜ is height of output data and Wₒᵤₜ is width of output data.

In some embodiments, the computation cost estimator is configured to compute the estimated computation cost T by using the following equation: T=2×N×Cₒᵤₜ×Hₒᵤₜ×Wₒᵤₜ×Cᵢₙ×KH×KW: (stride of the convolution).

In some embodiments, the memory/cache cost estimator is configured to perform the memory/cache cost estimation strategy comprising: reading input tensor from a cache or a memory; checking whether the input tensor is needed for successive layers; caching the input tensor if the input tensor is needed for successive layers and the tensor size of the input tensor is smaller than cache size; popping the input tensor from the cache if the input tensor is not needed for successive layers or the tensor size of the input tensor is bigger than cache size; updating cache status, and caching the output tensor until there is no free space in the cache.

In some embodiments, the memory/cache cost estimator is configured to perform the memory/cache cost estimation strategy comprising: reading the weight tensor from a cache or a memory; and caching the weight tensor until there is no free space in the cache.

In some embodiments, the memory/cache cost estimator is configured to perform the memory/cache cost estimation strategy comprising: for any of the input tensor, the output tensor and the wright tensor; not caching tensor if the tensor size is bigger than cache size; caching the tensor if the tensor can fit in free space of the cache; and clearing the cache and caching the tensor if the tensor cannot fit in the free space of the cache.

In some embodiments, the hardware specifications comprises TOPS of processor, memory bandwidth and last level cache (LLC).

In some embodiments, the hardware-aware cost model is constructed on top of intermediate representation (IR) builder.

Some non-limiting examples are provided below. Each of the examples stands as a separate embodiment itself.

Example 1 includes a hardware-aware cost model for optimizing inference of a deep neural network (DNN) comprising: a computation cost estimator configured to compute estimated computation cost based on input tensor, weight tensor and output tensor from the DNN; and a memory/cache cost estimator configured to perform memory/cache cost estimation strategy based on hardware specifications, wherein the hardware-aware cost model is used to perform performance simulation on target hardware to provide dynamic quantization knobs to quantization as required for converting a conventional precision inference model to an optimized inference model based on the result of the performance simulation.

Example 2 includes the hardware-aware cost model of Example 1, wherein the conventional precision inference model comprises FP32 model.

Example 3 includes the hardware-aware cost model of any of Examples 1-2, wherein the optimized inference model comprises Bfloat16 model, Bfloat8 model and INT8 model.

Example 4 includes the hardware-aware cost model of any of Examples 1-3, wherein the quantization is post-training quantization.

Example 5 includes the hardware-aware cost model of any of Examples 1-4, wherein the input tensor has four dimensions and is represented as input (N, Cᵢₙ, Hᵢₙ, Wᵢₙ), wherein N is batch size, Cᵢₙ is input channel count; Hᵢₙ is height of input data and Wᵢₙ is width of input data.

Example 6 includes the hardware-aware cost model of any of Examples 1-5, wherein the weight tensor has four dimensions and is represented as input (Cₒᵤₜ, Cᵢₙ, KH, KW), wherein Cₒᵤₜ is output channel count, Cᵢₙ is input channel count; KH is kernel height and KW is kernel width.

Example 7 includes the hardware-aware cost model of any of Examples 1-6, wherein the output tensor has four dimensions and is represented as input (N, Cₒᵤₜ, Hₒᵤₜ, Wₒᵤₜ), wherein N is batch size, Cₒᵤₜ is output channel count; Hₒᵤₜ is height of output data and Wₒᵤₜ is width of output data.

Example 8 includes the hardware-aware cost model of any of Examples 1-7, wherein the computation cost estimator is configured to compute the estimated computation cost T by using the following equation: T=2×N×Cₒᵤₜ×Hₒᵤₜ×Wₒᵤₜ×Cᵢₙ×KH×KW÷(stride of the convolution).

Example 9 includes the hardware-aware cost model of any of Examples 1-8, wherein the memory/cache cost estimator is configured to perform the memory/cache cost estimation strategy comprising: reading the input tensor from a cache or a memory; checking whether the input tensor is needed for successive layers; caching the input tensor if the input tensor is needed for successive layers and the tensor size of the input tensor is smaller than cache size; popping the input tensor from the cache if the input tensor is not needed for successive layers or the tensor size of the input tensor is bigger than cache size; updating cache status, and caching the output tensor until there is no free space in the cache.

Example 10 includes the hardware-aware cost model of any of Examples 1-9, wherein the memory/cache cost estimator is configured to perform the memory/cache cost estimation strategy comprising: reading the weight tensor from a cache or a memory; and caching the weight tensor until there is no free space in the cache.

Example 11 includes the hardware-aware cost model of Example 9 or 10, wherein the memory/cache cost estimator is configured to perform the memory/cache cost estimation strategy comprising: for any of the input tensor, the output tensor and the wright tensor; not caching tensor if the tensor size is bigger than cache size; caching the tensor if the tensor can fit in free space of the cache; and clearing the cache and caching the tensor if the tensor cannot fit in the free space of the cache.

Example 12 includes the hardware-aware cost model of any of Examples 1-11, wherein the hardware specifications comprises TOPS of processor, memory bandwidth and last level cache (LLC).

Example 13 includes the hardware-aware cost model of Example 12, wherein the processor comprises Copper Lake (CLX) processor, Cascade Lake (CPX) processor and Sapphire Rapids (SPR) processor.

Example 14 includes the hardware-aware cost model of any of Examples 1-13, wherein the hardware-aware cost model is constructed on top of intermediate representation (IR) builder.

Example 15 includes a method for optimizing inference of deep neural network (DNN) comprising: constructing a hardware-aware cost model comprising: a computation cost estimator configured to compute estimated computation cost based on input tensor, weight tensor and output tensor from the DNN; and a memory/cache cost estimator configured to perform memory/cache cost estimation strategy based on hardware specifications, and using the hardware-aware model to perform performance stimulation on target hardware to provide dynamic quantization knobs to quantization as required for converting a conventional precision inference model to an optimized inference model based on the result of the performance simulation.

Example 16 includes the method of Example 15, wherein the conventional precision inference model comprises FP32 model.

Example 17 includes the method of any of Examples 15-16, wherein the optimized inference model comprises Bfloat 16 model, Bfloat8 model and INT8 model.

Example 18 includes the method of any of Examples 15-17, wherein the quantization is post-training quantization.

Example 19 includes the method of any of Examples 15-18, wherein the input tensor has four dimensions and is represented as input (N, Cᵢₙ, Hᵢₙ, Wᵢₙ), wherein N is batch size, Cᵢₙ is input channel count; Hᵢₙ is height of input data and Wᵢₙ is width of input data.

Example 20 includes the method of any of Examples 15-19, wherein the weight tensor has four dimensions and is represented as input (Cₒᵤₜ, Cᵢₙ, KH, KW), wherein Cₒᵤₜ is output channel count, Cᵢₙ is input channel count; KH is kernel height and KW is kernel width.

Example 21 includes the method of any of Examples 15-20, wherein the output tensor has four dimensions and is represented as input (N, Cₒᵤₜ, Hₒᵤₜ, Wₒᵤₜ), wherein N is batch size, Cₒᵤₜ is output channel count; Hₒᵤₜ is height of output data and Wₒᵤₜ is width of output data.

Example 22 includes the method of any of Examples 15-21, wherein the computation cost estimator is configured to compute the estimated computation cost T by using the following equation: T=2 XNXCoutXHoutXWoutXCinxKHxKW=(stride of the convolution).

Example 23 includes the method of any of Examples 15-22, wherein the memory/cache cost estimator is configured to perform the memory/cache cost estimation strategy comprising: reading the input tensor from a cache or a memory; checking whether the input tensor is needed for successive layers; caching the input tensor if the input tensor is needed for successive layers and the tensor size of the input tensor is smaller than cache size; popping the input tensor from the cache if the input tensor is not needed for successive layers or the tensor size of the input tensor is bigger than cache size; updating cache status, and caching the output tensor until there is no free space in the cache.

Example 24 includes the method of any of Examples 15-23, wherein the memory/cache cost estimator is configured to perform the memory/cache cost estimation strategy comprising: reading the weight tensor from a cache or a memory; and caching the weight tensor until there is no free space in the cache.

Example 25 includes the method of Example 23 or 24, wherein the memory/cache cost estimator is configured to perform the memory/cache cost estimation strategy comprising: for any of the input tensor, the output tensor and the wright tensor; not caching tensor if the tensor size is bigger than cache size; caching the tensor if the tensor can fit in free space of the cache; and clearing the cache and caching the tensor if the tensor cannot fit in the free space of the cache.

Example 26 includes the method of any of Examples 15-25, wherein the hardware specifications comprises TOPS of processor, memory bandwidth and last level cache (LLC).

Example 27 includes the method of Example 26, wherein the processor comprises Copper Lake (CLX) processor, Cascade Lake (CPX) processor and Sapphire Rapids (SPR) processor.

Example 28 includes the method of any of Examples 15-27, wherein the hardware-aware cost model is constructed on top of intermediate representation (IR) builder.

Example 29 includes a computer-readable storage medium with program instructions stored thereon which, when executed by a processor, cause the processor to: construct a hardware-aware cost model comprising: a computation cost estimator configured to compute estimated computation cost based on input tensor, weight tensor and output tensor from the DNN; and a memory/cache cost estimator configured to perform memory/cache cost estimation strategy based on hardware specifications, and use the hardware-aware model to perform performance stimulation on target hardware to provide dynamic quantization knobs to quantization as required for converting a conventional precision inference model to an optimized inference model based on the result of the performance simulation.

Example 30 includes the computer-readable storage medium of Example 29, wherein the conventional precision inference model comprises FP32 model.

Example 31 includes the computer-readable storage medium of any of Examples 29-30, wherein the optimized inference model comprises Bfloat16 model, Bfloat8 model and INT8 model.

Example 32 includes the computer-readable storage medium of any of Examples 29-31, wherein the quantization is post-training quantization.

Example 33 includes the computer-readable storage medium of any of Examples 29-32, wherein the input tensor has four dimensions and is represented as input (N, Cᵢₙ, Hᵢₙ, Wᵢₙ), wherein N is batch size, Cᵢₙ is input channel count; Hᵢₙ is height of input data and Wᵢₙ is width of input data.

Example 34 includes the computer-readable storage medium of any of Examples 29-33, wherein the weight tensor has four dimensions and is represented as input (Cₒᵤₜ, Cᵢₙ, KH, KW), wherein Cₒᵤₜ is output channel count, Cᵢₙ is input channel count; KH is kernel height and KW is kernel width.

Example 35 includes the computer-readable storage medium of any of Examples 29-34, wherein the output tensor has four dimensions and is represented as input (N, Cₒᵤₜ, Hₒᵤₜ, Wₒᵤₜ), wherein N is batch size, Cₒᵤₜ is output channel count; Hₒᵤₜ is height of output data and Wₒᵤₜ is width of output data.

Example 36 includes the computer-readable storage medium of any of Examples 29-35, wherein the computation cost estimator is configured to compute the estimated computation cost T by using the following equation: T=2×N×Cₒᵤₜ×Hₒᵤₜ×Wₒᵤₜ×Cᵢₙ×KH×KW=(stride of the convolution).

Example 37 includes the computer-readable storage medium of any of Examples 29-36, wherein the memory/cache cost estimator is configured to perform the memory/cache cost estimation strategy comprising: reading the input tensor from a cache or a memory; checking whether the input tensor is needed for successive layers; caching the input tensor if the input tensor is needed for successive layers and the tensor size of the input tensor is smaller than cache size; popping the input tensor from the cache if the input tensor is not needed for successive layers or the tensor size of the input tensor is bigger than cache size; updating cache status, and caching the output tensor until there is no free space in the cache.

Example 38 includes the computer-readable storage medium of any of Examples 29-37, wherein the memory/cache cost estimator is configured to perform the memory/cache cost estimation strategy comprising: reading the weight tensor from a cache or a memory; and caching the weight tensor until there is no free space in the cache.

Example 39 includes the computer-readable storage medium of Example 37 or 38, wherein the memory/cache cost estimator is configured to perform the memory/cache cost estimation strategy comprising: for any of the input tensor, the output tensor and the wright tensor; not caching tensor if the tensor size is bigger than cache size; caching the tensor if the tensor can fit in free space of the cache; and clearing the cache and caching the tensor if the tensor cannot fit in the free space of the cache.

Example 40 includes the computer-readable storage medium of any of Examples 29-39, wherein the hardware specifications comprises TOPS of processor, memory bandwidth and last level cache (LLC).

Example 41 includes the computer-readable storage medium of Example 40, wherein the processor comprises Copper Lake (CLX) processor, Cascade Lake (CPX) processor and Sapphire Rapids (SPR) processor.

Example 42 includes the computer-readable storage medium of any of Examples 29-41, wherein the hardware-aware cost model is constructed on top of intermediate representation (IR) builder.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1-25. (canceled)

26. A hardware-aware cost model for optimizing inference of a deep neural network (DNN) comprising:
a computation cost estimator configured to compute estimated computation cost based on input tensor, weight tensor and output tensor from the DNN; and
a memory/cache cost estimator configured to perform memory/cache cost estimation strategy based on hardware specifications,
wherein the hardware-aware cost model is used to perform performance simulation on target hardware to provide dynamic quantization knobs to quantization as required for converting a conventional precision inference model to an optimized inference model based on the result of the performance simulation.

27. The hardware-aware cost model of claim 26, wherein the quantization is post-training quantization.

28. The hardware-aware cost model of claim 26, wherein the conventional precision inference model comprises FP32 model.

29. The hardware-aware cost model of claim 26, wherein the optimized inference model comprises Bfloat16 model, Bfloat8 model and INT8 model.

30. The hardware-aware cost model of claim 26, wherein the hardware-aware cost model is constructed on top of intermediate representation (IR) builder.

31. The hardware-aware cost model of claim 26, wherein the input tensor has four dimensions and is represented as input (N, Cᵢₙ, Hᵢₙ, Wᵢₙ), wherein N is batch size, Cᵢₙ is input channel count, Hᵢₙ is height of input data and Wᵢₙ is width of input data.

32. The hardware-aware cost model of claim 31, wherein the weight tensor has four dimensions and is represented as input (Cₒᵤₜ, Cᵢₙ, KH, KW), wherein Cₒᵤₜ is output channel count, Cᵢₙ is input channel count, KH is kernel height and KW is kernel width.

33. The hardware-aware cost model of claim 32, wherein the output tensor has four dimensions and is represented as input (N, Cₒᵤₜ, Hₒᵤₜ, Wₒᵤₜ), wherein N is batch size, Cₒᵤₜ is output channel count, Hₒᵤₜ is height of output data and Wₒᵤₜ is width of output data.

34. The hardware-aware cost model of claim 33, wherein the computation cost estimator is configured to compute the estimated computation cost T by using the following equation:
$$T = 2 \times N \times {C}_{out} \times {H}_{out} \times {W}_{out} \times {C}_{in} \times K H \times KW \div ( stride of convolution ) .$$

35. The hardware-aware cost model of claim 26, wherein the memory/cache cost estimator is configured to perform the memory/cache cost estimation strategy comprising:
reading the input tensor from a cache or a memory;
checking whether the input tensor is needed for successive layers;
caching the input tensor if the input tensor is needed for successive layers and the tensor size of the input tensor is smaller than cache size;
popping the input tensor from the cache if the input tensor is not needed for successive layers or the tensor size of the input tensor is bigger than cache size;
updating cache status, and
caching the output tensor until there is no free space in the cache.

36. The hardware-aware cost model of claim 26, wherein the memory/cache cost estimator is configured to perform the memory/cache cost estimation strategy comprising:
reading weight tensor from a cache or a memory; and
caching the weight tensor until there is no free space in the cache.

37. The hardware-aware cost model of claim 35, wherein the memory/cache cost estimator is configured to perform the memory/cache cost estimation strategy comprising:
for any of the input tensor, the output tensor and the wright tensor;
not caching tensor if the tensor size is bigger than cache size;
caching the tensor if the tensor can fit in free space of the cache; and
clearing the cache and caching the tensor if the tensor cannot fit in the free space of the cache.

38. A method for optimizing inference of deep neural network (DNN) comprising:
constructing a hardware-aware cost model comprising:
a computation cost estimator configured to compute estimated computation cost based on input tensor, weight tensor and output tensor from the DNN; and
a memory/cache cost estimator configured to perform memory/cache cost estimation strategy based on hardware specifications, and
using the hardware-aware model to perform performance stimulation on target hardware to provide dynamic quantization knobs to quantization as required for converting a conventional precision inference model to an optimized inference model based on the result of the performance simulation.

39. The method of claim 38, wherein the quantization is post-training quantization.

40. The method of claim 38, wherein the conventional precision inference model comprises FP32 model.

41. The method of claim 38, wherein the optimized inference model comprises Bfloat16 model, Bfloat8 model and INT8 model.

42. The method of claim 38, wherein the hardware-aware cost model is constructed on top of intermediate representation (IR) builder.

43. The method of claim 38, wherein the input tensor has four dimensions and is represented as input (N, Cᵢₙ, Hᵢₙ, Wᵢₙ), wherein N is batch size, Cᵢₙ is input channel count, Hᵢₙ is height of input data and Wᵢₙ is width of input data.

44. The method of claim 43, wherein the weight tensor has four dimensions and is represented as input (Cₒᵤₜ, Cᵢₙ, KH, KW), wherein Cₒᵤₜ is output channel count, Cᵢₙ is input channel count, KH is kernel height and KW is kernel width.

45. The method of claim 44, wherein the output tensor has four dimensions and is represented as input (N, Cₒᵤₜ, Hₒᵤₜ, Wₒᵤₜ), wherein N is batch size, Cₒᵤₜ is output channel count, Hₒᵤₜ is height of output data and Wₒᵤₜ is width of output data.

46. The method of claim 45, wherein the computation cost estimator is configured to compute the estimated computation cost T by using the following equation:
$$T = 2 \times N \times {C}_{out} \times {H}_{out} \times {W}_{out} \times {C}_{in} \times K H \times KW \div ( stride of convolution ) .$$

47. The method of claim 38, wherein the memory/cache cost estimator is configured to perform the memory/cache cost estimation strategy comprising:
reading the input tensor from a cache or a memory;
checking whether the input tensor is needed for successive layers;
caching the input tensor if the input tensor is needed for successive layers and the tensor size of the input tensor is smaller than cache size;
popping the input tensor from the cache if the input tensor is not needed for successive layers or the tensor size of the input tensor is bigger than cache size;
updating cache status, and
caching the output tensor until there is no free space in the cache.

48. The method of claim 38, wherein the memory/cache cost estimator is configured to perform the memory/cache cost estimation strategy comprising:
reading the weight tensor from a cache or a memory; and
caching the weight tensor until there is no free space in the cache.

49. The method of claim 47, wherein the memory/cache cost estimator is configured to perform the memory/cache cost estimation strategy comprising:
for any of the input tensor, the output tensor and the wright tensor;
not caching tensor if the tensor size is bigger than cache size;
caching the tensor if the tensor can fit in free space of the cache; and
clearing the cache and caching the tensor if the tensor cannot fit in the free space of the cache.

50. A computer-readable storage medium with program instructions stored thereon which, when executed by a processor, cause the processor to implement the method of claim 38.
